(19) United States
(12) Patent Application Publication
(10) Pub. No.: US 2008/0094538 A1
(43) Pub. Date: Apr. 24, 2008

(54) REFLECTING PLATE AND LIQUID CRYSTAL DISPLAY APPARATUS

(76) Inventors: Katsumasa Yoshii, Fukushima-ken (JP); Chie Chikira, Fukushima-ken (JP)

Correspondence Address: BRINKS HOFER GILSON & LIONE, P.O. BOX 10395, CHICAGO, IL, 60610, US

(21) Appl. No.: 11/874,624

(22) Filed: Oct. 18, 2007

(30) Foreign Application Priority Data
Oct. 20, 2006 (JP) 2006-285717

(51) Int. Cl. G02F 1/1335; G02B 5/02

(52) U.S. Cl. 349/64; 359/599

(57) ABSTRACT

A reflecting plate and a liquid crystal display device using the reflecting plate are provided capable of diffusing an incident light beam coming from a wide range of angles in a uniform manner while increasing the reflectivity at a main viewing angle. The reflecting plate includes a plurality of concave portions with a rounded surface formed thereon. The minimum tilt angle of the bottom surface of the concave portion with respect to the level plane is greater than 0.

### RELATED APPLICATIONS

This application claims the benefit of priority under 35 U.S.C. § 119 to Japanese Patent Application No. 2006-285717 filed Oct. 20, 2006, which is hereby incorporated by reference.

### BACKGROUND

1. Technical Field

The present disclosure relates to a reflecting plate for use in a reflective or semi-transmissive liquid crystal display device.

2. Description of the Related Art

In the past, liquid crystal display devices have been generally used as a display unit of small portable apparatuses such as a portable phone, a PDA (personal digital assistant), an electronic dictionary, a notebook computer (see for example, U.S. Pat. No. 6,429,919 corresponding to Japanese Unexamined Patent Application Publication No. 11-52110 (Patent Document 1)). Among these, reflective or semi-transmissive liquid crystal display devices are provided with a reflecting plate (referred to as “reflector” in Patent Document 1) that reflects an incident light beam coming from a display surface to display images. The deflecting plate is configured to diffuse a light beam in directions symmetrical with respect to a regular reflection angle; that is, when a light beam is incident onto a liquid crystal display panel disposed in a direction perpendicular to a normal viewing direction, an incidence angle of the incident light beam is equal to the regular reflection angle.

The reflecting plate is formed, for example, by preparing a plurality of continuous concave portions on a surface thereof. As the concave portion, one can be contemplated having a substantially circular shape in plan view and having a smooth rounded surface in sectional view, that is, of which the minimum tilt angle of the bottom surface with respect to the level plane is 0.

Recently, demands for liquid crystal display devices having a high reflectivity are seen in small portable apparatuses. In conventional liquid crystal display devices, in order to increase the reflectivity, there is used a method of decreasing the maximum tilt angle of the reflecting plate. This method can increase a peak reflectivity, but disadvantageously, the range of diffusion with respect to the regular reflection angle is narrowed. As a result, the reflectivity may decrease at a main viewing angle from which a viewer (a user of the small portable apparatuses or the like) mainly observes the liquid crystal display panel. Thus, a bright display can be provided only for a limited range of incidence angle.

### SUMMARY

According to an aspect of the disclosure, there is provided a reflecting plate having a plurality of concave portions with a rounded surface formed thereon, wherein the minimum tilt angle of the bottom surface of the concave portion with respect to the level plane is greater than 0. It is best if the minimum tilt angle is set so as to be in the range of about 0 to about 7.5 degrees.

According to such a configuration, the reflectivity in the vicinity of the regular reflection angle is suppressed low, thus decreasing production of glittering or dazzling light beams in the vicinity of the regular reflection angle. Also, the reflectivity at the main viewing angle is increased, thus improving a visual perceptibility. It is also possible to diffuse an incident light beam coming from a wide range of angles in a uniform manner.

In one embodiment of the reflecting plate of the disclosure, the concave portion preferably has a substantially oval shape in plan view for desirable results.

In one embodiment, it is preferable if the concave portion has a substantially circular shape in plan view.

According to another aspect of the disclosure, there is provided a liquid crystal display device equipped with the reflecting plate. According to a further aspect of the disclosure, there is provided a small portable apparatus equipped with the liquid crystal display device. According to such configurations, it is possible to achieve a liquid crystal display device and a small portable apparatus capable of displaying images with a visual perceptibility better than the conventional one.

### BRIEF DESCRIPTION OF THE DRAWINGS

The components in the figures are not necessarily to scale, emphasis instead being placed upon illustrating the principles of the disclosure. Moreover, in the figures, like referenced numerals designate corresponding parts throughout the different views.

FIG. 1 is a diagram showing a liquid crystal display device in accordance with an embodiment of the disclosure.

FIG. 2 is a perspective view showing a reflecting plate in accordance with an embodiment of the disclosure.

FIG. 3 is a diagram showing a concave portion formed on the reflecting plate of FIG. 2.

FIG. 4 is a diagram showing an incidence angle of an incident light beam and a regular reflection angle when a liquid crystal display device is disposed in a direction perpendicular to a normal viewing direction.

FIG. 5 is a diagram showing a relation between a scattering angle and a reflectivity when a normal direction to the surface of a liquid crystal display panel is set to 0 degree.

FIG. 6 is a diagram showing another example of the concave portion formed on the reflecting plate of FIG. 2.

FIGS. 7A to 7F are diagrams for explaining a method of manufacturing a reflecting plate in accordance with an embodiment of the disclosure.

FIG. 8 is a diagram showing reflection characteristics of the liquid crystal display device of an embodiment of the disclosure.

### DESCRIPTION OF THE EXEMPLARY EMBODIMENTS

Exemplary embodiments may be better understood with reference to the drawings, but these examples are not intended to be of a limiting nature. Like numbered elements in the same or different drawings perform equivalent or corresponding functions.

By narrowing the range of diffusion with respect to the regular reflection angle, the overall reflectivity can be increased to some extent. That is, the reflectivity is more or less increased at a viewing angle in the range of about 0 to about 20 degrees from the regular reflection angle. However, the reflectivity is also increased at a viewing angle in the vicinity of the regular reflection angle. As a result, a glittering or dazzling light beam may be produced at such a viewing angle in the vicinity of the regular reflection angle, thus deteriorating a viewer's visual perceptibility of the viewer.

The disclosure has been made based on findings that the glittering or dazzling light beam caused by a relatively high reflectivity at the viewing angle in the vicinity of the regular reflection angle deteriorates the visual perceptibility. In the disclosure, the reflectivity is suppressed low in the vicinity of the regular reflection angle, thus increasing the reflectivity at a viewing angle. That is, the minimum tilt angle of the bottom surface of a concave portion having a rounded surface on a reflecting plate is set so as to be greater than about 0 with respect to the level plane. It is best if the minimum tilt angle is set so as to be in the range of about 0 to about 7.5 degrees. By doing this, it becomes possible to diffuse an incident light beam coming from a wide range of angles in a uniform manner while increasing the reflectivity at a main viewing angle without deteriorating diffusion characteristics of the reflecting plate.

That is, a concept of this disclosure is to provide a plurality of concave portions having a rounded surface to a reflecting plate, in which the minimum tilt angle of the bottom surface of the concave portion with respect to the level plane is greater than about 0. Additionally, the minimum tilt angle is in the range of about 0 to about 7.5 degrees for best results. In this way, the reflecting plate becomes possible to diffuse an incident light beam coming from a wide range of angles in a uniform manner while increasing the reflectivity at a main viewing angle without deteriorating diffusion characteristics of the reflecting plate.

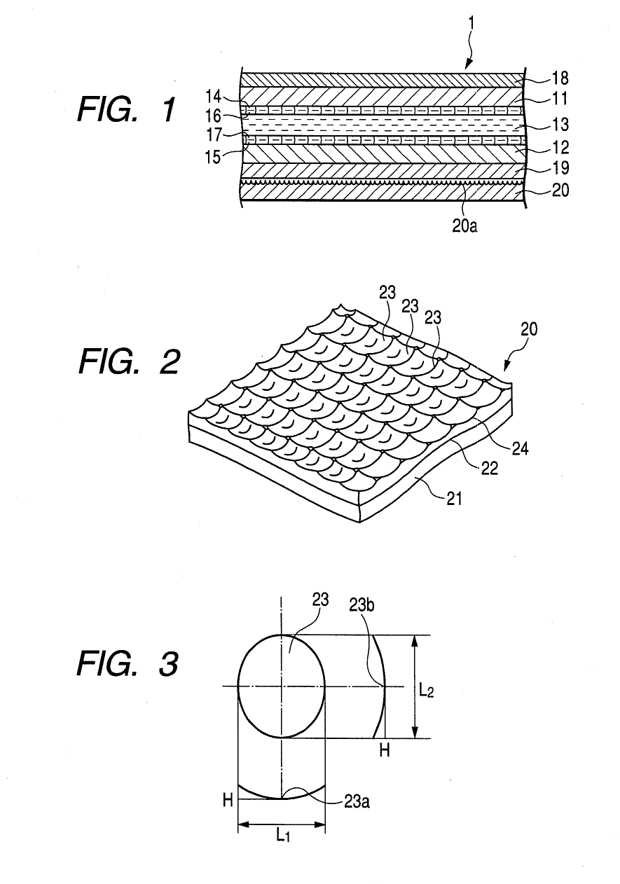

FIG. 1 is a diagram showing a liquid crystal display device in accordance with an embodiment of the disclosure. The liquid crystal display device 1 includes a pair of glass substrates 11 and 12 and a liquid crystal layer 13 that is disposed between the glass substrates 11 and 12. Each of the glass substrates 11 and 12 is provided with transparent electrodes 14 and 15 and orientation films that are provided on each of the transparent electrodes 14 and 15. Additionally, a pair of polarization plates 18 and 19 are disposed outside the glass substrates 11 and 12. A reflecting plate 20 is disposed outside one (the polarization plate 19) of the polarization plates in a state in which a reflecting surface 20a is directed toward the polarization plate 19.

In this liquid crystal display device 1, a light beam incident on the polarization plate 18 is linearly polarized by the polarization plate 18. The linearly polarized light beam is then elliptically polarized when the light beam passes through the liquid crystal layer 13. The elliptically polarized light beam is then linearly polarized again by the polarization plate 19. Then, the linearly polarized light beam is reflected from the reflecting plate 20 and outputted from the polarization plate 18 after passing through the polarization plate 19 and the liquid crystal layer 13.

FIG. 2 is a perspective view showing the reflecting plate 20 of FIG. 1. The reflecting plate 20 is mainly composed of a substrate 21 such as a glass substrate and a tabular resin base material 22 that is provided on the substrate 21 and made, for example, of a photosensitive resin. On the surface of the resin base material 22, a plurality of concave portions 23 are formed in succession in an overlapping manner. The inner surfaces of the concave portions 23 constitute a part of the rounded surface of the reflecting plate 20. In addition, a thin film 24 made, for example, of aluminum or sliver is deposited or printed on the resin base material 22. The reflecting plate 20 has a characteristic of scattering a light beam in directions symmetrical with respect to a regular reflection angle (such a characteristic being referred to as “symmetrical characteristic”).

FIG. 3 is a diagram shown in the concave portion 23 of the reflecting plate 20. The concave portion 23 may have a substantially oval shape in plan view. That is, in the drawing, the vertical length L2 of the oval shape is set so as to be greater than the horizontal length L1. In the section taken along the shorter side L1, the minimum tilt angle of a bottom surface 23a of the concave portion 23 with respect to the level plane H may be set so as to be in the range of 0 to 7.5 degrees. It is best if the minimum tilt angle is about 5 degrees. In the section taken along the longer side L2, the minimum tilt angle of a bottom surface 23b of the concave portion 23 with respect to the level plane H may be set so as to be substantially 0 (thus forming a smooth rounded surface).

The reflection characteristic of the reflecting plate 20 is determined depending on the shape of the concave portion 23. When the shape of the concave portion 23 is considered as a set of mirrors obtained by finely dividing the shape into a set of micro mirrors, a tilt angle distribution itself, which is a distribution histogram of a tilt angle of each of the mirrors, reflects the reflection characteristic as a whole. When an angle (tilt angle) of the bottom surface of the concave portion with respect to the level plane is 5 degrees, a regular reflection may occur at this tilt angle. The greater an absolute value of the tilt angle, the more likely a light beam is to be diffused. If the shape of the concave portion is symmetrical, the reflection characteristic will have a substantially uniform distribution in a tilt angle range including the tilt angle of 0 (i.e., including the regular reflection angle). Therefore, to decrease the reflectivity in the vicinity of the regular reflection angle, it is necessary to decrease the frequency (the existence ratio) of the tilt angles in the vicinity of the tilt angle of 0. Based on this idea, in the section taken along the shorter side L1, the minimum tilt angle of the bottom surface 23a of the concave portion 23 with respect to the level plane H is configured so as to be greater than 0. Moreover, the minimum tilt angle is configured so as to be in the range of about 0 to about 7.5 degrees for best results.

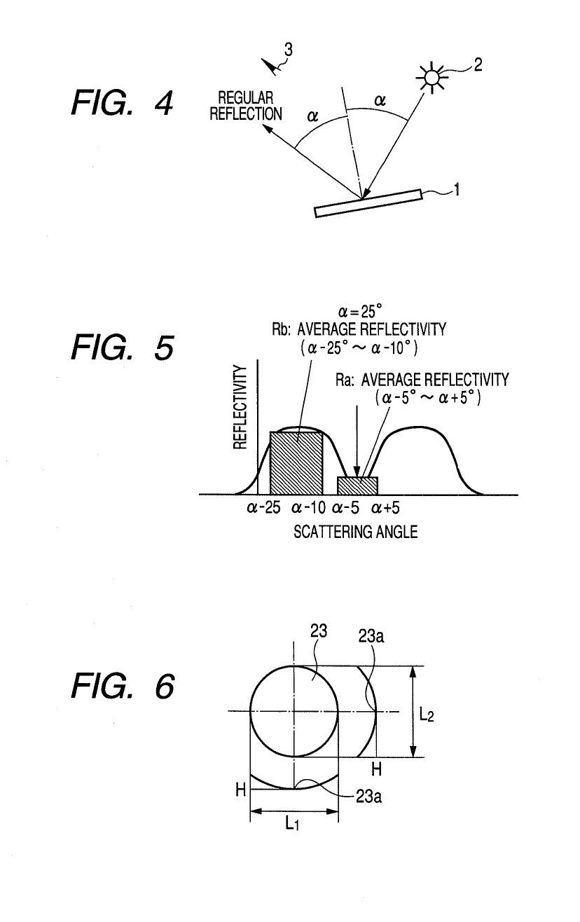

According to the reflecting plate 20 having such a concave portion 23, it is possible to suppress the reflectivity low in the vicinity of the regular reflection angle and thus to increase the reflectivity at the main viewing angle. As shown in FIG. 4, when the liquid crystal display device 1 is disposed in a direction perpendicular to a normal viewing direction, an incidence angle α of the incident light beam coming from a light source 2 is equal to a regular reflection angle α. In this disclosure, the case is considered in which a viewer 3 observes the liquid crystal display device 1 in the direction of the regular reflection angle.

FIG. 5 is a diagram showing a relation between a scattering angle and a reflectivity when a normal direction to the surface of a liquid crystal display panel of the liquid crystal display device 1 is set to 0 degree. As can be seen from the relation shown in FIG. 5, in the reflecting plate 20 having such a concave portion 23 as illustrated in FIG. 3, an average reflectivity at scattering angles in the vicinity of the regular reflection angle (i.e., angles in the range of (α−5) degrees to (α+5) degrees) is lower than the average reflectivity at scattering angles corresponding to the main viewing angle in the range of (α−25) degrees to (α−10) degrees. Accordingly, it is possible to decrease production of dazzling light beams at the regular reflection angle while increasing the reflectivity at the main viewing angle, thus improving a visual perceptibility.

In FIG. 5, a relation of Ra<C·Rb (where, C is a coefficient) is satisfied between the average reflectivity Ra at scattering angles in the vicinity of the regular reflection angle ranging from (α−5) degrees to (α+5) degrees and the average reflectivity Rb at scattering angles corresponding to the main viewing angle ranging from (α−25) degrees to (α−10) degrees. In this case, considering reduction of the dazzling light beams at the regular reflection angle, the coefficient C is 0.5 or less for best results. That is, it is best if the scattering angle of the incident light beam scattered from the reflecting plate and the reflectivity measured at the scattering angle satisfy a relation that an average reflectivity at the scattering angle in the range of (α−5) degrees to (α+5) degrees, where α, being the regular reflection angle, is equal to or smaller than a half of the average reflectivity at the scattering angle in the range of (α−25) degrees to (α−10) degrees.

The concave portion 23 may have such a shape as illustrated in FIG. 6. The concave portion 23 of FIG. 6 has a substantially circular shape in plan view. That is, in the drawing, the vertical length L2 of the oval shape is set so as to be equal to the horizontal length L1. In the sections taken along the sides L1 and L2, the minimum tilt angle of the bottom surface 23a of the concave portion 23 with respect to the level plane H is configured so as to be greater than 0. The minimum tilt angle is configured so as to be in the range of about 0 to about 7.5 degrees, for best results. It is best if the minimum tilt angle is about 5 degrees. According to the reflecting plate provided with the concave portion having such a shape, the intensity of the reflected light beam becomes substantially the same for any directions. Thus, it is possible to provide a uniform brightness for any viewing directions (angles).

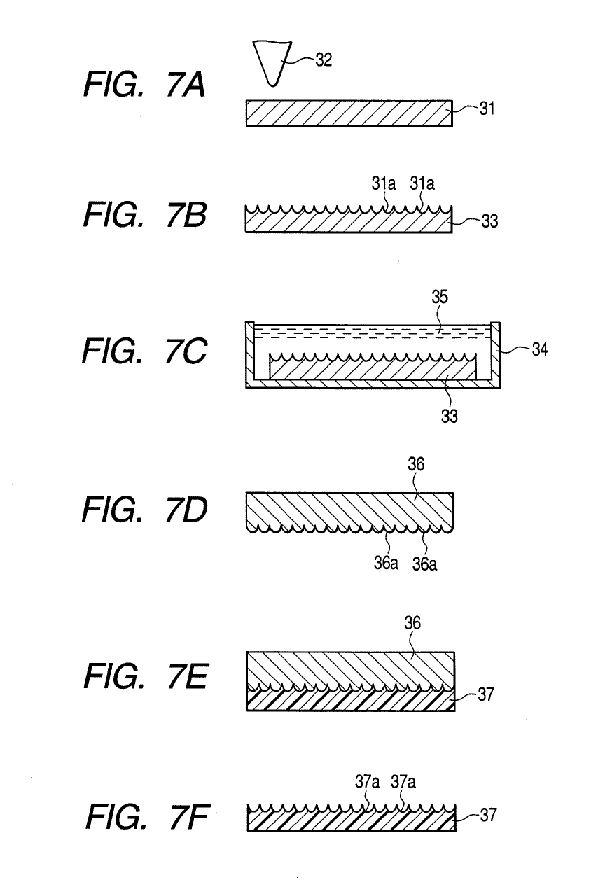

Next, a method of manufacturing the reflecting plate 20 will be described with reference to FIGS. 7A to 7F. FIGS. 7A to 7F are diagrams for explaining a method of manufacturing the reflecting plate in accordance with an embodiment of the disclosure.

First, as shown in FIG. 7A, a tabular matrix base material 31 which is made, for example, of brass, stainless steel, or tool steel and which has a flat surface is fixed on the table of a rolling apparatus (not shown). Then, a diamond indenting tool 32 of which the distal end is of elliptical, ship-bottom shape is pressed against the surface of the matrix base material 32, and the matrix base material 31 is moved horizontally before the diamond indenting tool 32 is vertically moved to press the surface again. This series of steps is repeated many times to roll a plurality of concave portions 31a having different depths and different pitches onto the surface of the matrix base material 31, thereby making a matrix 33 for forming the reflector as shown in FIG. 7B.

After that, as shown in FIG. 7C, the matrix 33 is placed in a box-shaped container 34, and a resin material 35 such as silicone resin is poured into the container 34. The resin material 35 is then left at room temperature until it hardens. The hardened resin part is taken out from the container 34, and unnecessary portions thereof are cut away. In this manner, a transfer mold 36 as shown in FIG. 7D is obtained having a mold surface 36a that has a plurality of convex portions corresponding to the plurality of concave portions of the mold surface of the matrix 33.

In the next step, a photosensitive resin liquid such as acrylic-based resist, polystyrene-based resist, rubber-azide-based resist, or imide-based resist is coated on the top surface of a glass substrate using coating methods such as a spin coating method, a screen printing method, or a spraying method. After completion of the coating process, a heating device such as a heating furnace or a hot plate is employed to pre-bake the photosensitive resin liquid on the glass substrate at a temperature in the range of, for example, 80 to 100 degrees Celsius for one minute or longer, thereby forming a photosensitive resin layer on the glass substrate.

After that, as illustrated in FIG. 7E, the mold surface 36a of the transfer mold 36 shown in FIG. 7D is held pressed against the photosensitive resin layer 37 on the glass substrate for a predetermined time, and the transfer mold 36 is removed from the photosensitive resin layer 37. In this way, the convex portions of the mold surface 36a are transferred onto the surface of the photosensitive resin layer 37 to form a plurality of concave portions 37a as shown in FIG. 7F. In the next step, light beams of ultraviolet rays or the like are irradiated from the rear surface side of the glass substrate, thus curing the photosensitive resin layer 37. Thereafter, by using the same heating device as that used for the pre-baking, the photosensitive resin layer 37 on the glass substrate is pre-baked at, for example, approximately 240 degrees Celsius for one minute or longer so as to burn the photosensitive resin layer 37 on the glass substrate.

Lastly, a film of aluminum, for example, is formed on the surface of the photosensitive resin layer 37 by means of electron beam deposition or the like to form a thin film along the surfaces of the concave portions, thereby obtaining the reflecting plate of the present embodiment. The method of fabricating the reflecting plate is not limited to the above-described method. For example, applicable methods include a method of patterning a resist using a photomask or a method of transferring a roll having an uneven surface printed thereon to a film.

Next, Example for demonstrating some advantages of this disclosure will be described.

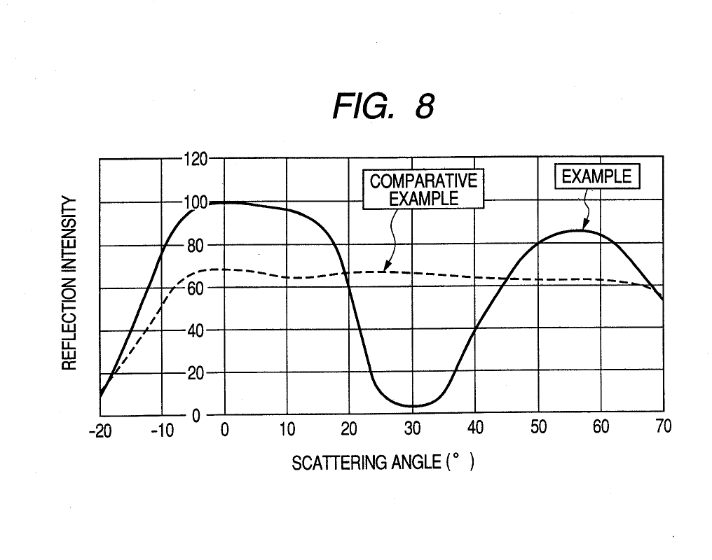

A reflective liquid crystal display device (Example) was fabricated having the reflecting plate 20 provided with a plurality of concave portions 23 having the shape shown in FIG. 3. The liquid crystal display device having the structure as illustrated in FIG. 1 was used. The reflection characteristic of the liquid crystal display device was investigated. FIG. 8 shows the results. As the reference characteristic, a relation between the scattering angle (degree) and the reference intensity was investigated when the incidence angle of an incident light beam was 30 degrees. A reflective liquid crystal display device (Comparative Example) was fabricated having a reflecting plate provided with a plurality of concave portions having a rounded surface of which the minimum tilt angle of the bottom surface with respect to the level plane is 0. Similarly, the reflection characteristic of the liquid crystal display device was investigated. FIG. 8 shows the results. The relation between the scattering angle and the reflection intensity was obtained by irradiating an external light beam (halogen lamp) at an incidence angle of 30 degrees and measuring the reflection light intensity while swinging a light receiving device (photodiode) at angles ranging from −20 degrees to 70 degrees with respect to a normal line.

As can be seen from the results shown in FIG. 8, in the liquid crystal display device of the Example, the reflection intensity was low at scattering angles in the vicinity of the regular reflection angle (the incidence angle) that are in the range of ±5 degrees from the regular reflection angle. Meanwhile, the reflection intensity was high at scattering angles corresponding to the main viewing angle that ranges from [(regular reflection angle)−25 degrees] to [(regular reflection angle)+10 degrees]. Incidentally, the average reflectivity Ra in the vicinity of the regular reflection angle was about 8.7 percents; the average reflectivity Rb at the main viewing angle was about 85.6 percents; and the coefficient C (Ra/Rb) was about 0.1. In this manner, the reflection intensity was suppressed low in the vicinity of the regular reflection angle, and a good visual perceptibility was achieved without production of glittering or dazzling light beams. Additionally, according to the liquid crystal display device of Example, it was possible to diffuse the incident light beam coming from a wide range of angles in a uniform manner. In addition, the reflection intensity was low in the vicinity of the regular reflection angle, but the reflection intensity at other ranges of the scattering angles was higher than that obtainable from the liquid crystal display device of the Comparative Example.

On the other hand, in the liquid crystal display device of the Comparative Example, the reflection intensity was substantially constant at scattering angles in the range of −10 degrees to −70 degrees. Incidentally, the average reflectivity Ra in the vicinity of the regular reflection angle was about 68.6 percents; the average reflectivity Rb at the main viewing angle was about 65.5 percents; and the coefficient C (Ra/Rb) was about 1.0. Consequently, glittering or dazzling light beams were produced in the vicinity of the regular reflection angle, thus deteriorating the visual perceptibility.

As described above, the reflecting plate of the present embodiment is configured to diffuse an incident light beam in directions symmetrical with respect to a regular reflection angle. The reflecting plate is provided with a plurality of concave portions. The minimum tilt angle of the bottom surface of the concave portion with respect to the level plane is configured so as to be greater than 0. Alternatively, the minimum tilt angle is configured so as to be in the range of about 0 to about 7.5 degrees for best results. According to the reflecting plate of the present embodiment, the reflectivity in the vicinity of the regular reflection angle can be suppressed low, thus decreasing production of glittering or dazzling light beams in the vicinity of the regular reflection angle. Also, the reflectivity at the main viewing angle is increased, thus improving a visual perceptibility. It is also possible to diffuse an incident light beam coming from a wide range of angles in a uniform manner.

The disclosure is not limited to the above-described exemplary embodiments but may be modified in various ways. For example, the structure of the liquid crystal display device described and illustrated in the embodiments or the material or shape of the layers including the electrodes may be changed in an appropriate manner without departing from the effect of the disclosure. The disclosure is not limited to the process described and illustrated in the embodiments but may be embodied in such a way that the order of process steps is changed.

The reflecting plate of the disclosure is applicable to a liquid crystal display device of small portable apparatuses such as a portable phone, a PDA (personal digital assistant), an electronic dictionary, a notebook computer

The terms and descriptions used herein are set forth by way of illustration only and are not meant as limitations. Those skilled in the art will recognize that many variations can be made to the details of the above-described embodiments without departing from the underlying principles of the disclosure. The scope of the disclosure should therefore be determined only by the following claims (and their equivalents) in which all terms are to be understood in their broadest reasonable sense unless otherwise indicated.

What is claimed is:

1. A reflecting plate having a plurality of concave portions with a rounded surface formed thereon, wherein the minimum tilt angle of the bottom surface of the concave portion with respect to the level plane is greater than 0.

2. The reflecting plate according to claim 1, wherein the minimum tilt angle of the bottom surface of the concave portion with respect to the level plane is in the range from greater about 0 to about 7.5 degrees.

3. The reflecting plate according to claim 1, wherein the concave portion has a substantially oval shape in plan view.

4. The reflecting plate according to claim 1, wherein the concave portion has a substantially circular shape in plan view.

5. The reflecting plate according to claim 1, wherein the reflecting plate is configured to diffuse an incident light beam in directions symmetrical with respect to a regular reflection angle, and a scattering angle of the incident light beam scattered therefrom and a reflectivity measured at the scattering angle satisfying a relation that an average reflectivity at the scattering angle in the range of (α−5) degrees to (α+5) degrees, where α, is the regular reflection angle, is equal to or smaller than a half of the average reflectivity at the scattering angle in the range of (α−25) degrees to (α−10) degrees.

6. A liquid crystal display device comprising the reflecting plate according to claim 1.

7. A small portable apparatus comprising the liquid crystal display device according to claim 6.
